(19) United States
(12) Patent Application Publication
(10) Pub. No.: US 2018/0160669 A1
(43) Pub. Date: Jun. 14, 2018

(54) A DEVICE FOR USE IN SEA FISHING

(71) Applicant: OPEN OCEAN TACKLE LTD, Cambridge (GB)

(72) Inventor: Anthony PIPE, Cambridge (GB)

(73) Assignee: OPEN OCEAN TACKLE LTD, Cambridge (GB)

(21) Appl. No.: 15/580,569

(22) PCT Filed: Jun. 7, 2016
(86) PCT No.: PCT/EP2016/062921

§ 371 Date: Dec. 7, 2017

(30) Foreign Application Priority Data
Jun. 8, 2015 (GB) 1509941.9

(51) Int. Cl. A01K 97/10; A01K 97/22; B63B 29/04

(52) U.S. Cl. CPC A01K 97/10; B63B 2029/043; B63B 29/04; A01K 97/22

(57) ABSTRACT

The invention provides a fishing chair for use in sea fishing; the fishing chair having pivotably mounted thereon a gimbal 2 comprising a socket structure for receiving a butt of a fishing rod; wherein a releasable restraining device is provided which can be set so as to prevent the gimbal from pivoting in a first direction, whereby pivoting movement of the gimbal in an opposite direction to the first direction serves to release the restraining device so that the gimbal can pivot in the said first direction. Also provided is a restraining device for use in the fishing chair of the invention.

This invention relates to a device for use in sea fishing and in particular fishing for large game fish such as tuna and marlin.

### BACKGROUND OF THE INVENTION

Big game fishing for fish such as bluefin tuna, blue marlin and black marlin is a physically very demanding sport and much effort has gone into developing heavy duty equipment sufficiently strong enough to withstand the rigours of use whilst keeping within the international rules governing big game fishing. Game fish such as tuna and marlin are significantly larger than the fish commonly encountered by on-shore fishermen or when fishing in on-shore waters. For example, Atlantic marlin typically average over 200 kg in weight while the average weight for bluefin tuna is typically in excess of 300 kg. As a result, much larger and stronger fishing rods and heavier gauge line are required in order to handle the larger sized fish.

Because of the weight of the rod and the weight, the strength and determination of the fish, and the length of time often taken to reel in a fish, it can be very arduous for a person to stand unsupported with a fishing rod throughout the entire period taken to land the fish. It is therefore customary to provide a boat with one or more fishing chairs in which a person may sit during his or her battle to land a fish. Fishing chairs are firmly anchored to the deck of a boat and are typically provided with a foot board or foot plate so that the fisherman can brace himself (or herself) against the forces exerted by a fish on the end of a fishing line which otherwise be sufficiently large to pull him (or her) out of the chair. Fishing chairs are often provided with pivotably mounted sockets, typically known as gimbals, into which the butt of the rod can be inserted once a fish has been hooked. The gimbals, which according to the rules of the International Game Fishing Association (IGFA) must be freely pivotable in pivot mountings on the chairs, enable the rod to be tilted forwards or backwards in order to slacken or tighten the fishing line as the line is reeled in. However, the gimbals do not, and are not intended to, provide a secure mounting for the rod which must be held firmly by the fisherman in order to prevent the rod from being pulled out of the gimbal.

When fishing for game fish such as tuna, it is customary to trail lines carrying bait off the back of the boat in order to attract the fish. The fishing rods from which the bait-laden lines extend are often mounted in rod holders arranged around the back or sides of a boat. The reels carrying the lines typically have a brake which is set to a certain weight so as to prevent line from being withdrawn from the reel until a fish has swallowed the bait and the hook has set in the fish. Once the hook has set, the fisherman will lift the rod out of the rod holder and make his way to the fishing chair where the butt of the rod will be inserted in the gimbal attached to the chair. The rod is then clipped to a harness worn around the waist of the fisherman. Battle with the fish will then commence.

One method commonly used in big game fishing is the bait and switch trolling method. In this method, several lines that carry bait but no hooks are dragged behind the boat in order to attract fish. The lines can be held by fishing rods mounted in rod holders at the edge of the boat deck. One or more rods carrying lines attached to baited hooks may also be mounted in rod holders around the edge of the deck, but the lines with hooks are kept out of the water until a fish has been attracted by the bait trailing behind the boat. Once a fish has been attracted to the trailing bait, the lines without hooks are reeled in and removed from the water and a line bearing a hook and bait is cast in their place. Once the fish has taken the bait and the hook has set into the fish, the fisherman will remove the rod from the rod holder and make his way to the fishing chair as described above.

A major problem for the fisherman is that because of the weight of the rod and the movement of the fish at the other end of the line, manoeuvring the rod around the boat while the boat is in motion, which will involve the rod being held with both hands while maintaining the rod at a 45 degree angle at the waist, can be not only tiring but also very difficult. The degree of difficulty is increased if the boat is rocking under the influence of waves. This can be a particular problem, for younger/weaker anglers, novices and more elderly anglers.

Problems can also arise when a fisherman hooks a fish which is too powerful for him to handle and, as result, the fisherman becomes too tired to continue. In such a situation, it is important to ensure that the fisherman can safely unclip the rod from the harness, or remove the harness, without the rod being lost over the side of the boat. In the event that the fisherman cannot remove the harness or unclip the rod from the harness, there is a risk that the fisherman may be pulled out of the boat.

U.S. Pat. No. 4,682,438 (Arrow) discloses a chair that includes a rod holder that permits a fishing rod to rotate about its longitudinal axis. U.S. Pat. No. 4,460,216 (Keller) discloses a chair comprising a seat structure and a fishing-pole socket in the form of a gimbal. Neither of the chairs disclosed in these documents comprise a restraining device to hold the fishing rod in a substantially upright position. Instead, the user must hold the fishing rod at all times during use.

U.S. Pat. No. 4,344,248 (Brophy) discloses an automatic hooksetting fishing rod holder. The document does not disclose the rod holder in conjunction with a fishing chair. The rod holder in U.S. Pat. No. 4,344,248 is configured for use on land (rather than on fishing boats) and is not intended for sea fishing.

Therefore, there exists the need for an improved fishing chair which does not suffer from the disadvantages of known fishing chairs, as described above.

### THE INVENTION

The invention addresses the abovementioned problems by providing a fishing chair which can function as a rod holder until the fish has taken the bait and the hook has set into the fish, after which the fisherman can take control of the rod and begin to play the fish in the usual manner. The fishing chair is provided with a pivoting gimbal but is also provided with a restraining device that can be engaged to hold the gimbal so that the rod is in a substantially upright position in which the rod is securely held in the gimbal and cannot readily be pulled out by a sudden tug on the fishing line. Once a fish of the desired weight has been hooked, and the reel brake limit is exceeded so that the line begins to unwind, the fisherman can return to the fishing chair without the need to manoeuvre the rod around the boat. However, the international rules of big game fishing preclude any mechanical assistance being used by a fisherman once the fish has been hooked and the fisherman has taken hold of the rod. Therefore, the fisherman cannot leave the fishing rod in the gimbal in the upright position. Instead, the restraining device must immediately be released. The restraining device is therefore configured and mounted so that once the fisherman has taken hold of the rod, moving the rod (e.g. by tilting the rod backwards towards the fisherman) automatically releases the restraining device so that the gimbal is free to pivot and is restrained from doing so only by the strength of the fisherman.

Thus, according to the invention, the fishing chair gimbal can be used as a rod holder thereby removing the need to carry the rod about the boat and saving valuable time which can make the difference between catching and losing a fish.

Accordingly, in one embodiment, the invention provides a fishing chair for use in sea fishing; the fishing chair having pivotably mounted thereon a gimbal comprising a socket structure for receiving a butt of a fishing rod; wherein a releasable restraining device is provided which can be set so as to prevent the gimbal from pivoting in a first direction, whereby pivoting movement of the gimbal in an opposite direction to the first direction serves to release the restraining device so that the gimbal can pivot in the said first direction.

The gimbal is typically pivotable about a transverse axis, the term “transverse axis” as used herein referring to a direction transverse to the direction in which a person faces when sitting in the chair and looking forward.

The “first direction” is typically a forwards direction, the term “forwards direction” referring to the direction in which the gimbal pivots when a rod mounted in the gimbal is tilted away from the fisherman.

The “opposite direction” is typically a rearwards direction, the term “rearwards direction” referring to the direction in which the gimbal pivots when a rod mounted in the gimbal is tilted towards the fisherman.

The releasable restraining device can be contained in or form part of the gimbal itself. For example, the releasable restraining device can take the form of a locking means associated with the pivot mounting for the gimbal.

Alternatively, the releasable restraining device can be a device which is separate from the gimbal and which can be brought into engagement with the gimbal to prevent pivoting in the first direction.

For example, in one embodiment, the releasable restraining device comprises a bracing member which, in order to prevent pivoting of the gimbal in the first direction, can be arranged so that it extends between a mounting point or contact point on the chair and a surface of the gimbal. Thus the bracing member can be placed in a bracing position in which it restrains the gimbal against pivoting movement in the first direction but, when the gimbal is pivoted in the opposite direction, the bracing member moves out of the bracing position so that the gimbal is then free to pivot in the first direction.

In another embodiment, the releasable restraining device comprises a flexible tether anchored at one end to the chair and being connected at another end thereof to a gimbal-engaging portion which can be releasably secured to or around the gimbal to prevent it from pivoting in the first direction. In this embodiment, when the gimbal-engaging portion is secured to or around the gimbal, the flexible tether is placed under tension, the tension serving to prevent pivoting of the gimbal. The gimbal-engaging portion can be, for example, a hook or other structure (e.g. a horseshoe-shaped member) that can hook over the gimbal to prevent it from pivoting in the first direction. The flexible tether can be, for example, a chain or cord and may comprise one or more strands. The cord(s) may have some elasticity to assist in providing the necessary tension to hold the gimbal against pivoting. It will be appreciated however that the tension in the flexible tether must not be so great that the releasable restraining device is not released when the gimbal is pivoted in the opposite direction to the said first direction. The flexible tether is anchored at a suitable location on the chair, for example to a foot plate of the chair. A second flexible tether may be provided to link the gimbal portion to another anchoring point on the chair. The second flexible tether, which typically is not maintained under tension but rather is loose, holds the gimbal engaging portion near to the gimbal after it has been released so that it can readily be engaged again.

The releasable restraining device may be configured so that it falls away from the gimbal under the influence of gravity upon pivoting movement of the gimbal in an opposite direction to the first direction e.g. when the fisherman pulls the rod towards himself to clip the rod to his harness.

In one particular embodiment, the releasable restraining device comprises a bracing member which is pivotably mounted on the fishing chair in such a way that it swings (e.g. downwardly under the influence of gravity) out of engagement with the gimbal when the gimbal pivots a rearwards direction, e.g. when the fisherman pulls the rod towards himself to clip the rod to his harness.

The releasable restraining device can therefore comprise a bracing member in the form of an arm configured to engage the gimbal and restrain the gimbal against forwards rotation, the said arm being connected to a pivot mounting secured to the fishing chair.

The arm can be arranged to pivot and fall away from the gimbal under the influence of gravity. The gimbal and the arm are therefore typically shaped to prevent the arm from falling away under the influence of gravity until the restraining device is required to be released.

In one embodiment, the arm is bifurcated at an end intended to engage the gimbal. The end of the arm can therefore have a pair of prongs which engage the gimbal so that it is held between the two prongs. In one embodiment, the end of the arm can be approximately horse-shoe shaped.

The gimbal is shaped so as to engage the bifurcated arm so that it does not fall away under the influence of gravity before the restraining device is required to be released. Thus, for example, the gimbal may have one or external grooves or protrusions that engage the bifurcated arm (e.g. the prongs thereof. Alternatively, or additionally, the gimbal may have a waisted shape such that the bifurcated arm engages a waist region of the waisted shape.

The restraining device is preferably extendable in length. Accordingly, the restraining device may comprise a pivot mounting for mounting the device on the chair, a gimbal-engaging portion, and a linking member connecting the gimbal-engaging portion to the pivot mounting, wherein means are provided for varying the distance between the gimbal-engaging portion and the pivot mounting. For example, the linking member can comprise a threaded shaft having a thread which engages a complementary thread in the pivot mounting and/or the gimbal-engaging portion, whereby rotation of the gimbal-engaging portion relative to the pivot mounting serves to vary the distance therebetween.

In another particular embodiment, the restraining device comprises a flexible tether formed from two or more strands of wire, cord or chain, each of which is anchored at one end to a footplate of the chair and is connected at another end thereof to a gimbal-engaging element which is configured to hook over the gimbal, and wherein tension in the said strands serves to prevent the gimbal from pivoting in the first direction. In this embodiment, a second flexible tether may be provide so that the gimbal-engaging element is kept near to the gimbal after the restraining device has been released.

The restraining device may be fitted to the chair during the manufacture of the chair or it may be retro-fitted to an existing chair.

Accordingly, in a further aspect, the invention provides a restraining device for use on a fishing chair; the fishing chair being of a type having mounted thereon a gimbal comprising a socket structure for receiving a butt of a fishing rod, the gimbal being pivotable about an axis (e.g. a transverse axis as defined herein); wherein the releasable restraining device when fitted to the fishing chair can be engaged with the gimbal to prevent it from pivoting in a first (e.g. forwards) direction and is released when the gimbal is rotated in a direction (e.g. a rearwards direction) opposite to the first direction.

Particular features of the restraining device are as set out above in relation to the fishing chair.

Further aspects and embodiments of the invention will be apparent from the claims appended hereto and the apparatus illustrated in the drawings and described below.

### BRIEF DESCRIPTION OF THE DRAWINGS

FIG. 1 is side view of a person sitting in a fishing chair according to one embodiment of the invention.

FIG. 2 is in an enlarged view of the gimbal and restraining arm arrangement of the fishing chair illustrated in FIG. 1.

FIG. 3 is a side view of the fishing chair of FIGS. 1 and 2 showing the position of the restraining device as the rod is tilted backwards.

FIG. 4 is a side view showing the position of the restraining device after the rod has been tilted backwards.

FIG. 5 is perspective view showing the fishing chair of FIGS. 1 to 4 without a rod in place.

FIG. 6 is an enlarged view showing the positions of the gimbal and restraining device in the fishing chair depicted in FIG. 5.

FIG. 7 is a perspective view of the underside of a fishing chair according to a second embodiment of the invention.

FIG. 8 is an enlarged view of the portion A in FIG. 7.

FIG. 9 is an enlarged view of part of the restraining device in the fishing chair shown in FIGS. 7 and 8.

FIG. 10 is a perspective view from another angle of the underside of the fishing chair of FIGS. 7 to 9.

FIG. 11 is an enlarged view of the portion B in FIG. 10.

FIG. 12 is a perspective view of the underside of a fishing chair according to a third embodiment of the invention.

FIG. 13 is an enlarged view of the portion A in FIG. 12.

FIG. 14 is an isometric view of the gimbal-engaging portion of the restraining device in the chair shown in FIGS. 12 and 13.

### DETAILED DESCRIPTION OF THE INVENTION

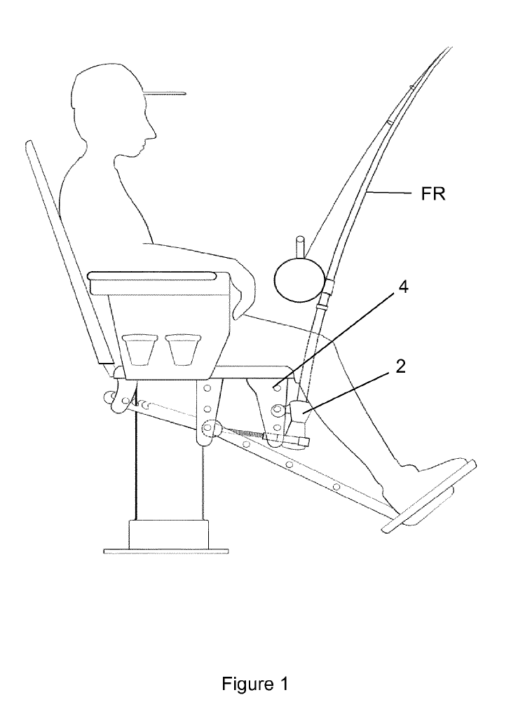

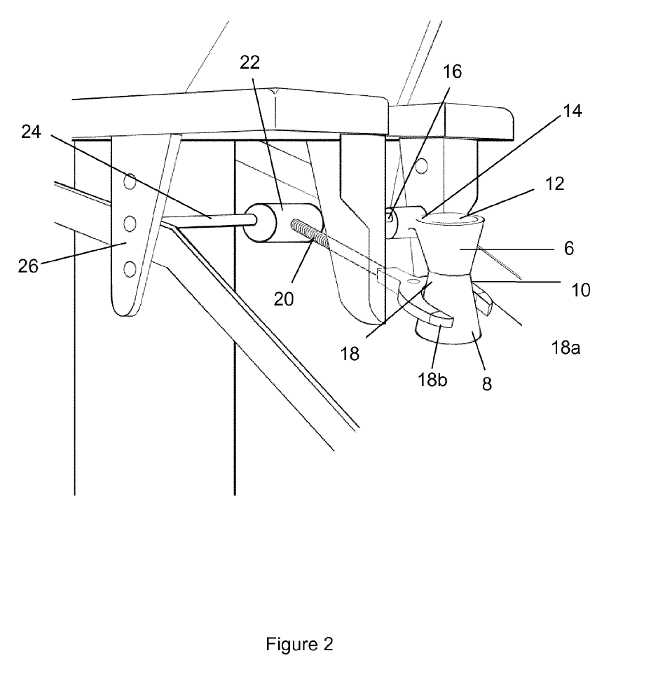

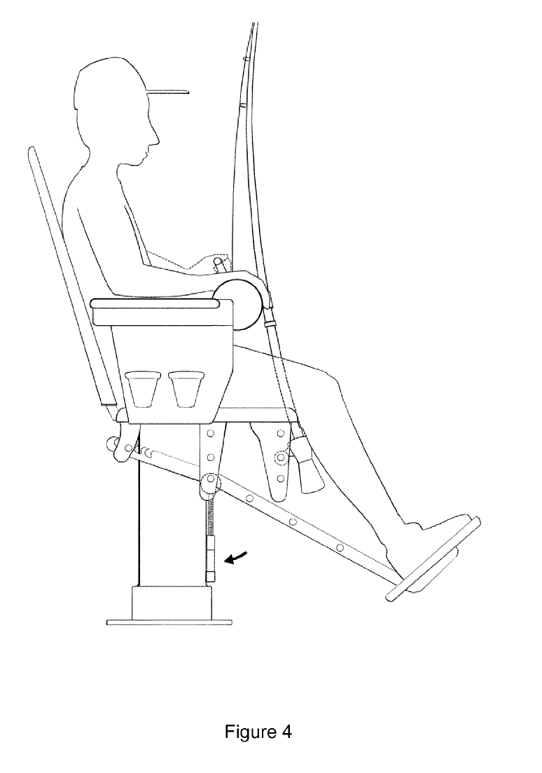

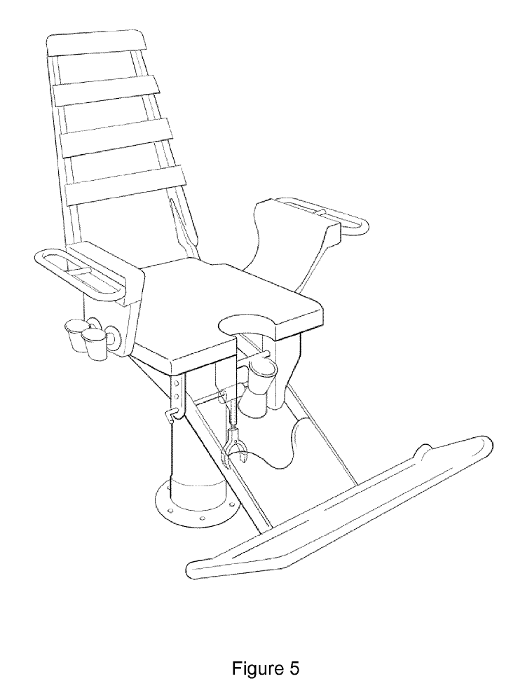

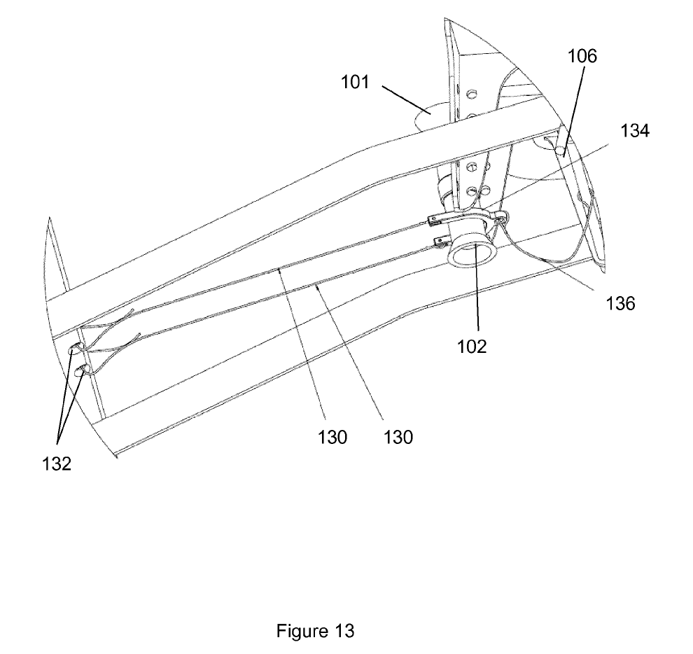

The invention will now be illustrated but not limited by reference to the specific embodiments shown in the drawings FIGS. 1 to 14.

FIG. 1 illustrates a fishing chair of generally conventional construction of the type used in game fishing boats, for example when fishing for large game fish such as tuna.

The fishing chair comprises a seat and a footrest that enables a user of the chair to brace himself (or herself) against forces exerted by a fish on the end of a fishing line which otherwise be sufficiently large to pull him (or her) out of the chair.

A gimbal 2 for a fishing rod FR is pivotably mounted on a frame member 4 on the underside of the chair. The holder 2 comprises a socket structure having a hollow interior 12 for receiving the butt of the fishing rod.

The socket structure, which may be formed for example from stainless steel or aluminium, has an external shape corresponding to a pair of truncated cones 6, 8 connected head to head, the region in which the heads of the two truncated cones meet defining a narrow point or “waist” 10. The socket structure of the gimbal 2 is connected to a pivot mounting 14 which is pivotably mounted on an axle attached to a frame member 16 extending downwardly from the underside of the chair.

The manner of mounting the gimbal (although not the shape of the socket structure) on the chair is conventional and allows the fisherman to anchor the butt of his rod so that the rod can be tilted backwards or forwards as necessary when reeling in a fish on the end of the fishing line.

However, the fishing chair differs from known fishing chairs in that it is provided with a restraining device for holding the gimbal 2 against rotation in a forwards direction.

The restraining device comprises a bracing element in the form of a horse-shoe shaped birfurcated member 18 having a pair of prongs 18a and 18b that embrace the socket structure. The bifurcated member 18 is linked by a threaded shaft 20 which is held in a threaded bore in a cylindrical pivot mounting 22. The pivot mounting 22 is rotatably mounted on a shaft 24 which is fixed to the frame member 26 extending from the underside of the chair. The shaft 24 passes through a bore extending through the pivot mounting 22. A tubular sleeve (not shown) of PTFE (or another low friction polymer) can be fitted on the shaft 24 so that it encircles the region of the shaft passing through the pivot mounting 22. The sleeve reduces friction between the shaft 24 and pivot mounting 22 thereby facilitating pivoting movement of the pivot mounting about the shaft 24. The sleeve also serves to prevent metal-to-metal contact between the pivot mounting 22 and the shaft 24 thereby preventing galvanic corrosion from occurring in the event that different metals are used to form the shaft 24 and mounting 22. The threaded shaft 20 provides a screw thread adjustment that enables the length of the restraining device to be varied. By varying the length of the restraining device, the angle of the gimbal 2 and hence the angle of the fishing rod FR can be varied.

In use, the line attached to the fishing rod FR is loaded with bait and the line is allowed to unwind to a suitable length off the back of the boat and the reel brake is set to a required weight (e.g. 70 lb). The restraining device is set to the position shown in FIG. 1 so that the two prongs 18a and 18b of the bifurcated member 18 embrace the gimbal 2 and slide down the lower frustoconical portion 8 until the diameter of the frustoconical portion 8 prevents the member 18 from sliding any further.

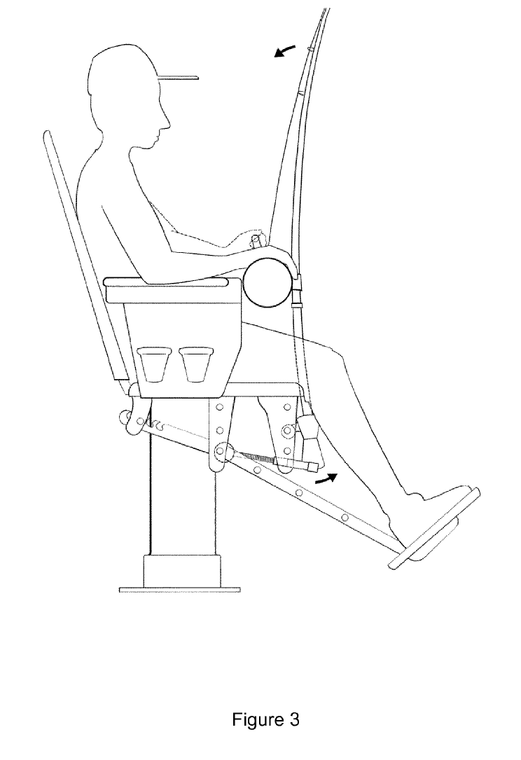

A fisherman can either sit in the chair waiting for a fish to take the bait or can vacate the chair until the fish bites. Once a fish of the required size takes the bait and pull exerted by the fish exceeds the reel brake setting, the reel will automatically unwind. The fisherman will then sit in the chair and clip the rod to a harness worn around his waist and, in doing so, will pull the rod backwards as shown in FIG. 3. As the rod FR is pulled backwards, the gimbal tilts backwards with it and the bifurcated member 18 slides down and off of the gimbal, as shown in FIGS. 3, 4, 5 and 6. The gimbal is then free to pivot.

Thus, the invention provides a simple mechanical device for restraining the gimbal in a more upright orientation in which it can hold rods during bait trailing but can quickly be released as soon as the fisherman takes hold of the rod. The device thereby avoids the problems encountered with known fishing chairs where the fisherman has to lift a heavy rod with a large fish on the end of the line out of a gimbal and manoeuvre the rod across the boat to the fishing chair. If the bait and switch trolling method is used, rods mounted in rod holders around the edges of the boat deck can be used to carry the lines bearing bait but no hooks, whereas a rod held in the gimbal attached to the fishing chair can be used to carry a line bearing a hook and bait. Thus, if desired, the need to carry a rod from a rod holder at the edge of the deck to the fishing chair before playing the fish can be avoided altogether.

A further advantage of the restraining device of the invention is that can provide greater safety in the event that a young or relatively weak or inexperienced angler hooks a large fish that is well beyond his capabilities or becomes so tired that he is unable to continue. In such a situation, the rod can be pulled back and another person on the boat can reattach the restraining device to the gimbal. Whilst landing the fish would not then be permitted under the IGFA rules, the angler could then safely unclip his harness from the rod and exit the chair and enable another fisherman to play and release the fish.

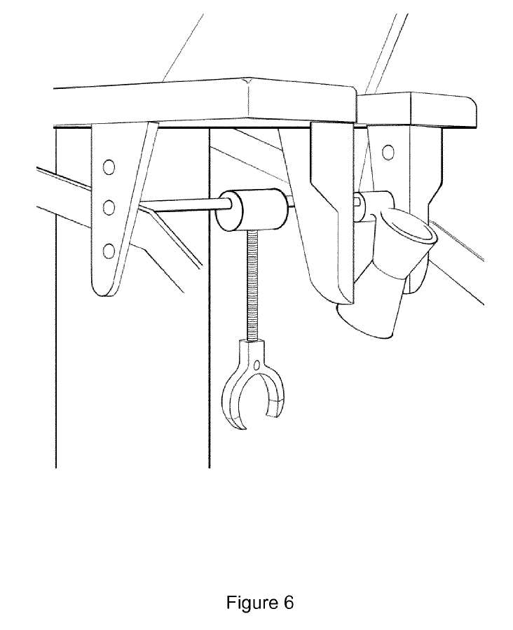

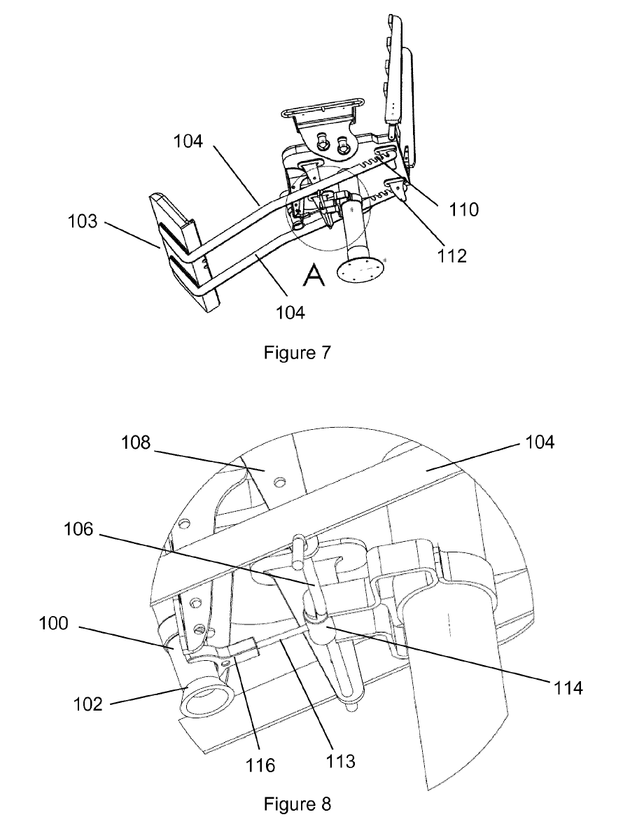

A fishing chair and restraining device according to a second embodiment of the invention is illustrated in FIGS. 7 to 11.

The fishing chair of FIGS. 7 to 11 is of similar construction to the fishing chair of FIGS. 1 to 6 but differs in relation to the shape of the gimbal and the restraining device used to restrain pivoting of the gimbal. In this embodiment, the gimbal 100 is of generally cylindrical form but has a flared upper end 101 into which the fishing rod is placed, and a frustoconical lower end 102. As with the chair illustrated in FIGS. 1 to 6, the chair shown in FIG. 7 has a footplate 103 which is attached to a pair of bars 104 which extend beneath the chair and are supported on a cross bar 106 mounted in brackets 108 extending downwardly from the underside of the chair. At the ends remote from the footplate, the bars 104 have a series of generally arc-shaped slots 110 which can accommodate lugs (not shown) on brackets 112 extending downwardly from the underside of the chair. The lugs and arc-shaped recesses cooperate to provide a mechanism for adjusting the position of the footplate 102 to accommodate people with different leg lengths.

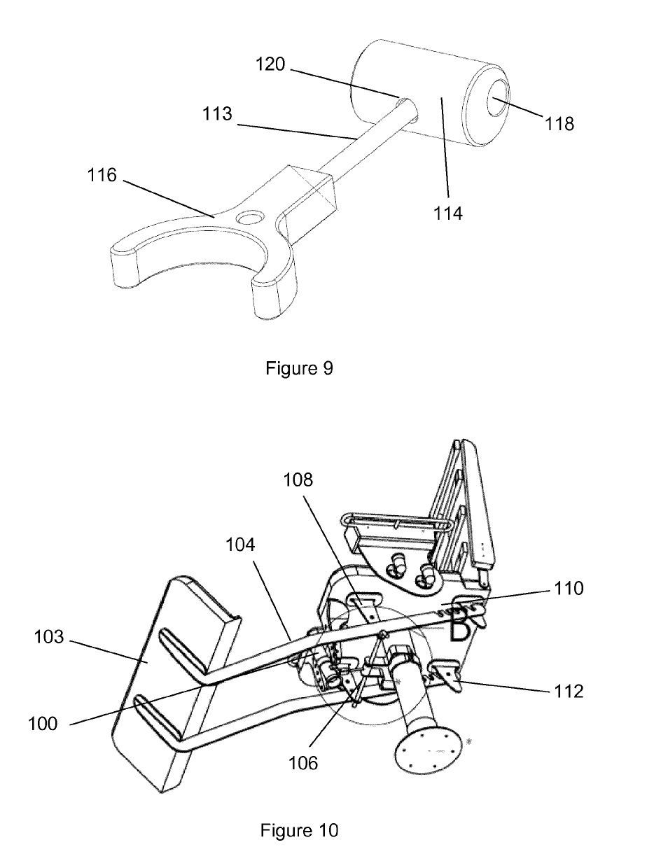

As with the chair of FIGS. 1 to 6, the chair of FIGS. 7 to 11 has a restraining device in the form of an arm 113 which is pivotally mounted on the cross bar 106 by means of the pivot mounting block 114. The arm 112 has a gimbal-engaging portion 116 similar to the bifurcated member 18 in the chair of FIGS. 1 to 6. Although not shown in FIGS. 7 to 11, the arm 113 and gimbal-engaging portion 116 may be provided with complementary threads to enable fine adjustment of the position of the gimbal-engaging portion 116. As can be seen more clearly in FIG. 9, the pivot mounting block 114 is of generally cylindrical form and has an eccentric bore 118, through which the cross bar 106 passes, and a threaded bore 120 for connection to the correspondingly threaded end of the arm 112. A tubular sleeve (not shown) formed from PTFE or another low friction polymer can be placed on the cross bar 106 so that it encircles the section of the cross bar passing through the eccentric bore 118. By placing a PTFE sleeve between the inner wall of the bore 118 and the cross bar 106, friction between the cross bar and the inner wall is reduced and the pivot block is able to pivot more freely. The sleeve also serves to prevent galvanic corrosion taking place through contact between the cross bar 106 and block 114 when they are formed from different metals (e.g. steel and aluminium).

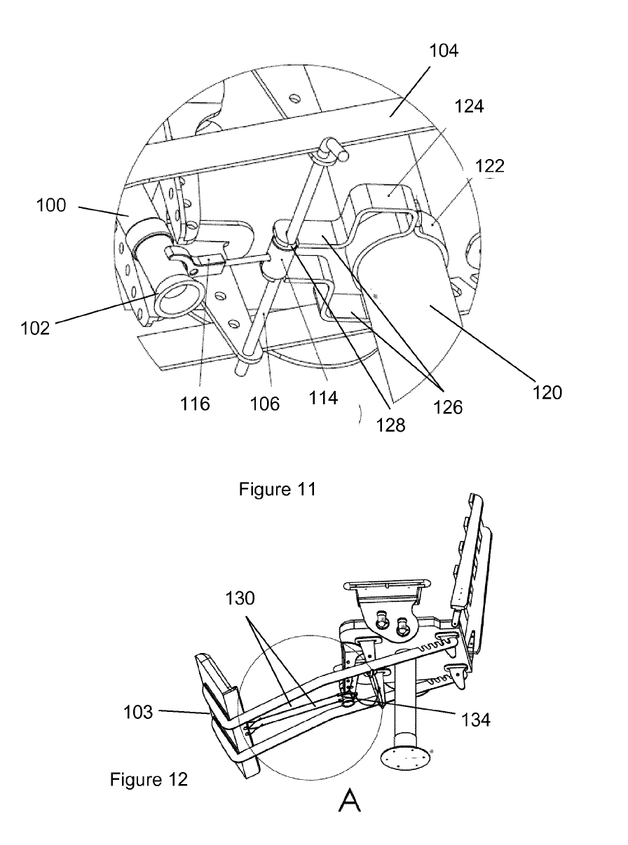

In both of the embodiments illustrated in FIGS. 1 to 11, the restraining device is mounted via a pivot block on the cross bar 106 supporting the arms of the footplate. In the event that a very large fish is hooked, the torque applied through the gimbal and the consequent force exerted through the arm 112 on the cross bar 106 could theoretically be large enough to bend the cross bar 106. In order to prevent this from happening, a further bracing structure can be attached to the pillar or stem 120 of the chair as shown in detail in FIGS. 8 and 11. The bracing structure comprises a pair of bracing elements 122, 124 which are clamped together about the pillar 120 by means of clamping bolts and nuts (not shown). The rear bracing element 122 is of semi-circular form and has a pair of end flanges for accommodating the clamping bolts. The front bracing element 124 has a semi-circular portion from which extend a pair of arms 126. The lower edges of the arms 126 are provided with open ended slots 128 which fit over the cross bar 106. The arms 126 of the bracing element 124 prevent the cross bar 106 from bending under the forces applied through the restraining device resulting from the hooking of a large fish.

A fishing chair according to a third embodiment of the invention is shown in FIGS. 12 to 14. The fishing chair of FIGS. 12 to 14 is generally similar to the chair illustrated in FIGS. 7 to 11 but lacks the additional bracing structure 122, 124 and has a different type of restraining device. Thus, instead of the pivot-mounted bracing arm arrangement shown in FIGS. 7 to 11, the fishing chair shown in FIGS. 12 to 14 is provided with a restraining device in the form of a flexible tether comprising a pair of tensioned wires or cords 130 which are each anchored at one end to the footplate 103 by means of loops of the wire or cord passing through holes 132 in the footplate. The other ends of the wires or cords 130 are secured to a horseshoe-shaped gimbal-engaging element 134. By way of example, the cords can be metal cables formed from multiple twisted metal wires or ropes formed from polymeric (e.g. polypropylene) or natural fibres. The wires or cords can be secured to the element 134 by means of D-shackles (not shown) passing through holes 135 in the ends of the arms of element 134. In order to restrain pivoting of the gimbal, the horseshoe-shaped gimbal-engaging element 134 can be hooked over the gimbal as shown in the drawings. The frustoconical lower end 102 of the gimbal prevents or reduces the likelihood of accidental dislodgement of the element 134 from the gimbal. In order to ensure that the element 134 remains close to the gimbal after release, so that it can quickly be reattached if necessary, a secondary tether 136 is provided. The secondary tether comprises a length of cord which, at one end, loops around the cross bar 106 and, at the other end, is fastened to the eyelet 138 in the element 134.

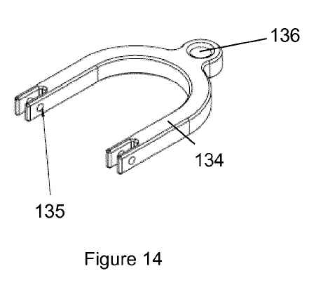

In order to release the restraining device, the gimbal is pivoted in a rearwards direction (as it would be if a rod mounted in the gimbal is pulled backwards) causing the horseshoe-shaped gimbal-engaging element 134 to fall away under the influence of gravity. The gimbal, and hence any rod held in the gimbal, is then free to pivot in a forwards direction. The presence of the secondary tether holds the element 134 close to the gimbal to facilitate quick reattachment and also prevents the element 134 from falling to the deck of the boat and either damaging the deck or being damaged itself. The length of the arms of the horseshoe-shaped gimbal-engaging element 134 is typically selected so as to provide optimal release of the element 134 from the gimbal when the rod is pulled backwards. Thus, for example, the arms may be shorter, relative to the width of the element 134, than is shown in FIG. 14 in order to facilitate more rapid release from the gimbal.

It will readily be apparent that numerous modifications and alterations could be made to the invention illustrated in FIGS. 1 to 14 without departing from the principles underlying the invention and all such modifications and alterations are intended to be embraced by this application.

1. A fishing chair for use in sea fishing; the fishing chair having pivotably mounted thereon a gimbal comprising a socket structure for receiving a butt of a fishing rod; wherein a releasable restraining device is provided which can be set so as to prevent the gimbal from pivoting in a first direction, whereby pivoting movement of the gimbal in an opposite direction to the first direction serves to release the restraining device so that the gimbal can pivot in the said first direction.

2. A fishing chair according to claim 1 wherein the releasable restraining device comprises a bracing member which extends between a mounting point or contact point on the chair and a surface of the gimbal.

3. A fishing chair according to claim 2 wherein the bracing member is in the form of an arm configured to engage the gimbal and restrain the gimbal against forwards rotation, the said arm being connected to a pivot mounting secured to the fishing chair.

4. A fishing chair according to claim 3, wherein the arm is arranged to pivot and fall away from the gimbal under the influence of gravity upon pivoting movement of the gimbal in an opposite direction to the first direction.

5. A fishing chair according to claim 4 wherein the arm is bifurcated at an end intended to engage the gimbal, the end of the arm having a pair of prongs which engage the gimbal so that it is held between the two prongs.

6. A fishing chair according to claim 5 wherein the end of the arm is approximately horse-shoe shaped.

7. A fishing chair according to claim 1 wherein the restraining device is extendable in length.

8. A fishing chair according to claim 7 wherein the restraining device comprises a pivot mounting for mounting the device on the chair, a gimbal-engaging portion, and a linking member connecting the gimbal-engaging portion to the pivot mounting, wherein the restraining device is configured to allow the distance between the gimbal-engaging portion and the pivot mounting to be varied.

9. A fishing chair according to claim 8 wherein the linking member comprises a threaded shaft having a thread which engages a complementary thread in the pivot mounting and/or the gimbal-engaging portion, whereby rotation of the gimbal-engaging portion relative to the pivot mounting serves to vary the distance therebetween.

10. A fishing chair according to claim 1 wherein the restraining device comprises a flexible tether anchored at one end to the chair and being connected at another end thereof to a gimbal-engaging portion which can be releasably secured to or around the gimbal to prevent it from pivoting in the first direction.

11. A fishing chair according to claim 10 wherein the restraining device comprises a flexible tether formed from two or more strands of wire, cord or chain, each of which is anchored at one end to a footplate of the chair and is connected at another end thereof to a gimbal-engaging element which is configured to hook over the gimbal, and wherein tension in the said strands serves to prevent the gimbal from pivoting in the first direction.

12. (canceled)

13. A restraining device for use on a fishing chair; the fishing chair being of a type having mounted thereon a gimbal comprising a socket structure for receiving a butt of a fishing rod, the gimbal being pivotable about an axis; wherein the releasable restraining device when fitted to the fishing chair can be engaged with the gimbal to prevent it from pivoting in a first direction and is released when the gimbal is rotated in a direction opposite to the first direction.

14. A restraining device according to claim 13 which when fitted to the fishing chair can be engaged with the gimbal to prevent it from pivoting in a forward direction and is released when the gimbal is rotated in a rearward direction.

15. A restraining device according to claim 13 comprising a bracing member which extends between a mounting point or contact point on the chair and a surface of the gimbal.

16. A restraining device according to claim 13 which is extendable in length.

17. A restraining device according to claim 16 comprising a pivot mounting for mounting the device on the chair, a gimbal-engaging portion, and a linking member connecting the gimbal-engaging portion to the pivot mounting, wherein the restraining device is configured to allow the distance between the gimbal-engaging portion and the pivot mounting to be varied.

18. A restraining device according to claim 17 wherein the linking member comprises a threaded shaft having a thread which engages a complementary thread in the pivot mounting and/or the gimbal-engaging portion, whereby rotation of the gimbal-engaging portion relative to the pivot mounting serves to vary the distance therebetween.

19. A restraining device to claim 13 comprising a flexible tether anchored at one end to the chair and being connected at another end thereof to a gimbal-engaging portion which can be releasably secured to or around the gimbal to prevent it from pivoting in the first direction.

20. A restraining device according to claim 19 comprising a flexible tether formed from two or more strands of wire, cord or chain, each of which in use is anchored at one end to a footplate of the chair and is connected at another end thereof to a gimbal-engaging element which is configured to hook over the gimbal, and wherein tension in the said strands serves to prevent the gimbal from pivoting in the first direction.
